(19) United States
(12) Patent Application Publication
(10) Pub. No.: US 2016/0236098 A1
(43) Pub. Date: Aug. 18, 2016

(54) SYSTEMS AND METHODS FOR PROVIDING EXTENDED IN-GAME CHAT

(71) Applicant: LIMITED LIABILITY COMPANY MAIL.RU GAMES, Moscow (RU)

(72) Inventor: Vitaly Chibrikov, Zelenograd (RU)

(21) Appl. No.: 15/000,022

(22) Filed: Jan. 18, 2016

Related U.S. Application Data
(63) Continuation of application No. PCT/RU2013/000624, filed on Jul. 19, 2013.

(51) Int. Cl. A63F 13/87; A63F 13/35

(52) U.S. Cl. CPC A63F 13/87; A63F 13/35

(57) ABSTRACT

A computerized system and an associated computer-implemented method for enabling in-game communication between a plurality of players participating in a game, the system incorporating: a game server configured to communicate with multiple game clients, each of the multiple game clients being directly accessed by one of multiple game players, the game server further configured to enable the game between the multiple game players, the game server incorporating a chat server, wherein the chat server incorporates multiple frontends, each frontend configured to communicate with a chat client to enable exchange of messages between chat clients and wherein at least one chat is separate and distinct from each of the multiple game clients.

### BACKGROUND OF THE INVENTION

1. Field of the Invention

The disclosed embodiments relate in general to the field of computer gaming technology and in particular to systems and methods for extending in-game chat to non-gaming clients.

2. Description of the Related Art

In-game chat functionality became an important part of modern gaming technology. Game players utilize the in-game chat to discuss the game and game-related topics with their friends and other game players. The availability of a chat with other game players greatly increases users' involvement in the game.

In-game chat is conventionally implemented using the gaming client software installed on client gaming devices as well as the gaming server. Therefore, the conventional gaming chat functionality may be used only through the gaming software, during active game session and by users involved in the game. Thus, using conventional technology it is impossible to communicate by way of in-game chat using other communication software applications or with users not involved in the active game session.

Therefore, new and improved systems and methods for implementing in-game chat are needed that would enable game players to communicate by way of in-game chat using other communication software applications or with users not involved in the active game session.

### SUMMARY OF THE INVENTION

The inventive methodology is directed to methods and systems that substantially obviate one or more of the above and other problems associated with conventional techniques for implementing in-game chat.

In accordance with one aspect of the embodiments described herein, there is provided a computerized system for enabling in-game communication between a plurality of players participating in a game, the system incorporating: a game server configured to communicate with a plurality of game clients, each of the plurality of game clients being directly accessed by one of the plurality of game players, the game server further configured to enable the game between the plurality of players, the game server comprising a chat server, wherein the chat server comprises a plurality of frontends, each frontend of the plurality of frontends configured to communicate with a chat client of a plurality of chat clients to enable exchange of messages between chat clients and wherein at least one chat client of the plurality of chat clients is separate and distinct from each of the plurality of game clients.

In one or more embodiments, the plurality of frontends comprises a web frontend, the plurality of chat clients comprises a web chat client, and wherein the web frontend is configured to communicate with the web chat client via an HTTP protocol.

In one or more embodiments, the web chat client is deployed on a web portal.

In one or more embodiments, the plurality of frontends comprises an XMPP frontend, the plurality of chat clients comprises an XMPP chat client, and wherein the XMPP frontend is configured to communicate with the XMPP chat client via an XMPP protocol.

In one or more embodiments, the game server comprises an in-game guild module and wherein the chat server is configured to relay messages between the in-game guild module and the plurality of chat clients.

In one or more embodiments, the game server comprises an in-game group module and wherein the chat server is configured to relay messages between the in-game group module and the plurality of chat clients.

In one or more embodiments, the game server comprises an in-game chat room module and wherein the chat server is configured to relay messages between the in-game chat room module and the plurality of chat clients.

In one or more embodiments, the plurality of frontends comprises an in-game frontend, the plurality of chat clients comprise an in-game chat client, the in-game chat client being deployed on one of the plurality of game clients and wherein the in-game frontend is configured to communicate with the in-game chat client using a game communication protocol.

In accordance with another aspect of the embodiments described herein, there is provided a computer-implemented method for enabling in-game communication between a plurality of players participating in a game, the computer-implemented method being performed in connection with a system incorporating: a game server comprising a chat server, the chat server comprising a plurality of frontends, the computer-implemented method involving: establishing a communication between the game server and a plurality of game clients directly accessed by one of the plurality of game players; using the game server to enable the game between the plurality of players; and establishing a communication between the plurality of frontends of the chat server and the plurality of chat clients, the plurality of frontends communicate with the plurality of chat clients to enable exchange of messages between the plurality of chat clients, wherein at least one chat client of the plurality of chat clients is separate and distinct from each of the plurality of game clients.

In one or more embodiments, the plurality of frontends comprises a web frontend, the plurality of chat clients comprises a web chat client, and wherein the web frontend is configured to communicate with the web chat client via an HTTP protocol.

In one or more embodiments, the web chat client is deployed on a web portal.

In one or more embodiments, the plurality of frontends comprises an XMPP frontend, the plurality of chat clients comprises an XMPP chat client, and wherein the XMPP frontend is configured to communicate with the XMPP chat client via an XMPP protocol.

In one or more embodiments, the game server comprises an in-game guild module and wherein the chat server is configured to relay messages between the in-game guild module and the plurality of chat clients.

In one or more embodiments, the game server comprises an in-game group module and wherein the chat server is configured to relay messages between the in-game group module and the plurality of chat clients.

In one or more embodiments, the game server comprises an in-game chat room module and wherein the chat server is configured to relay messages between the in-game chat room module and the plurality of chat clients.

In one or more embodiments, the plurality of frontends comprises an in-game frontend, the plurality of chat clients comprise an in-game chat client, the in-game chat client being deployed on one of the plurality of game clients and wherein the in-game frontend is configured to communicate with the in-game chat client using a game communication protocol.

In one or more embodiments, the communication between the plurality of frontends of the chat server and the plurality of chat clients is established based on credentials assigned to each of the plurality of game players.

In accordance with yet another aspect of the embodiments described herein, there is provided a non-transitory computer-readable medium embodying a set of computer-readable instructions, which, when executed in connection with a computerized system incorporating a game server, the game server comprising a chat server, the chat server comprising a plurality of frontends, cause the computerized system to perform a computer-implemented method for enabling in-game communication between a plurality of players participating in a game, the method involving: establishing a communication between the game server and a plurality of game clients directly accessed by one of the plurality of game players; using the game server to enable the game between the plurality of players; and establishing a communication between the plurality of frontends of the chat server and the plurality of chat clients, the plurality of frontends communicate with the plurality of chat clients to enable exchange of messages between the plurality of chat clients, wherein at least one chat client of the plurality of chat clients is separate and distinct from each of the plurality of game clients.

In one or more embodiments, the plurality of frontends comprises a web frontend, the plurality of chat clients comprises a web chat client, and wherein the web frontend is configured to communicate with the web chat client via an HTTP protocol.

In one or more embodiments, the web chat client is deployed on a web portal.

In one or more embodiments, the plurality of frontends comprises an XMPP frontend, the plurality of chat clients comprises an XMPP chat client, and wherein the XMPP frontend is configured to communicate with the XMPP chat client via an XMPP protocol.

In one or more embodiments, the game server comprises an in-game guild module and wherein the chat server is configured to relay messages between the in-game guild module and the plurality of chat clients.

In one or more embodiments, the game server comprises an in-game group module and wherein the chat server is configured to relay messages between the in-game group module and the plurality of chat clients.

In one or more embodiments, the game server comprises an in-game chat room module and wherein the chat server is configured to relay messages between the in-game chat room module and the plurality of chat clients.

In one or more embodiments, the plurality of frontends comprises an in-game frontend, the plurality of chat clients comprise an in-game chat client, the in-game chat client being deployed on one of the plurality of game clients and wherein the in-game frontend is configured to communicate with the in-game chat client using a game communication protocol.

In one or more embodiments, the communication between the plurality of frontends of the chat server and the plurality of chat clients is established based on credentials assigned to each of the plurality of game players.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a computerized system for enabling extended in-game chat functionality.

FIG. 2 illustrates an exemplary operating sequence of an embodiment of the computer-implemented method for enabling extended in-game chat functionality.

FIG. 3 is a block diagram that illustrates an embodiment of a computer system upon which an embodiment of the inventive functionality may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more embodiments described herein, there are provided systems and methods for implementing in-game chat that enable game players to communicate by way of in-game chat using other communication software applications or with users not involved in the active game session.

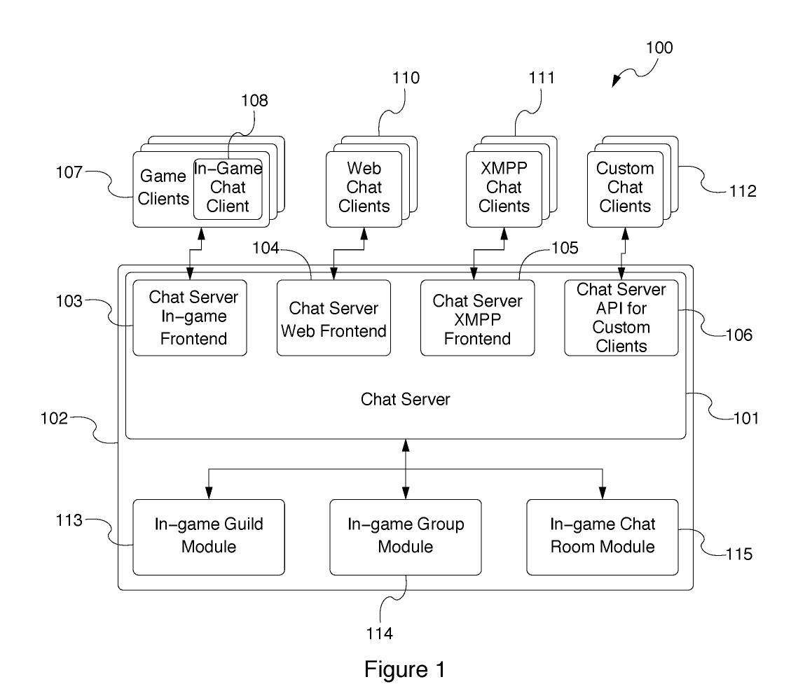

FIG. 1 illustrates an exemplary embodiment of a computerized system 100 for enabling extended in-game chat functionality. The illustrated embodiment of the system 100 incorporates a special in-game chat server 101, which is a part of the gaming server 102. In one or more embodiments, the in-game chat server 101 is configured to interact with the game's social interation functionality, such as in-game communities, which may include in-game guilds, in-game groups and in-game chat rooms. To this end, the chat server 101 is configured to exchange data with the in-game guild module 113, in-game group module 114 and in-game chat room module 115. As would be appreciate by those of skill in the art, the in-game guild is an organised group of game players that regularly play together in the multiplayer game. I various embodiments, the in-game guild module 113 manages creation of in-game guilds, adding/removing game players to/from in-game guilds as well as handling of communication between players within the in-game guilds. The in-game group module 114 and the in-game chat room module 115 provides a similar functionality for in-game groups and chat rooms, respectively.

In one or more embodiments, the chat server 101 incorporates frontend modules 103, 104, 105 and 106, configured to enable access to the in-game chat functionality provided by the in-game chat server 101 from different types of client devices. For example, the in-game chat server in-game frontend 103 is provided to facilitate the access of the in-game chat server 101 using the game client 107. To enable in-game chat functionality, each of the game clients 107 is provided with in-game chat client 108, which is configured to exchange data, including, without limitation, chat messages, with the chat server in-game frontend 103. In one embodiment, the game client 107 connects to the in-game chat server in-game frontend 103 using the internal in-game protocol, as the game chat implemented using the game client 107 is a part of the game and all the messages and events in the chat are indistinguishable from the corresponding gaming messages and events.

In one or more embodiments, the chat server 101 further incorporates in-game chat web frontend module 104 configured to interact with the multiple web chat clients 110. In one or more embodiments, each of the web chat clients 110 and the web frontend module 104 exchange data using HTTP protocol well known to persons of ordinary skill in the art. In one embodiment, the data, such as chat messages, may be exchanged using GET and/or POST commands well known to persons of ordinary skill in the art.

In one or more embodiments, the in-game chat server XMPP frontend 105 is configured to communicate with XMPP chat client 111 via the XMPP protocol well know to persons of ordinary skill in the art. Exemplary XMPP chat clients 111 include, without limitation, IM+, iChat, Crosstalk, and many others. In addition, the in-game chat server API for custom chat clients 106 is configured to communicate with one or more custom chat clients 112 using any now known or later developed communication protocol(s). Exemplary embodiments of custom chat clients 112 include, without limitation, Skype client, Gtalk client and the like, which are all well known to persons of ordinary skill in the art.

In one or more embodiments, the in-game chat server 101 is configured to relay data, such as formatted chat messages and/or other content, between the chat clients 108, 110, 111 and 112 and between the aforesaid client and the game's social interation modules 113, 114 and 115. In one implementation, each of the game's social interation modules 113, 114 and 115 may implement its own chat room.

In one embodiment, each player of the game is provided with access credentials to the in-game chat server 101 in order to use the in-game chat functionality. In one embodiment, the user can use the aforesaid credentials to access the chat functionality provided by the in-game chat server 101 from any of the chat clients 108, 110, 11 and 112. The aforesaid access credentials entitle the user to access all of the in-game social interaction functionality provided by the social interation modules 113, 114 and 115.

Therefore, participation in the in-game social interaction is available not only when the user uses the game client 107, but also at any time when the user has access to the chat server using any of the clients 108, 110, 111 and 112 via the Internet. In one or more embodiments, each user can connect to the chat server 101 by one or many of the described chat clients at once. For example, the user can connect to chat server 101, using the game client 107 and by the web page (web chat client 110) at the same time. In this case, the user will receive incoming chat messages in both chat clients. Likewise, the user is able to send messages from both of the aforesaid chat clients.

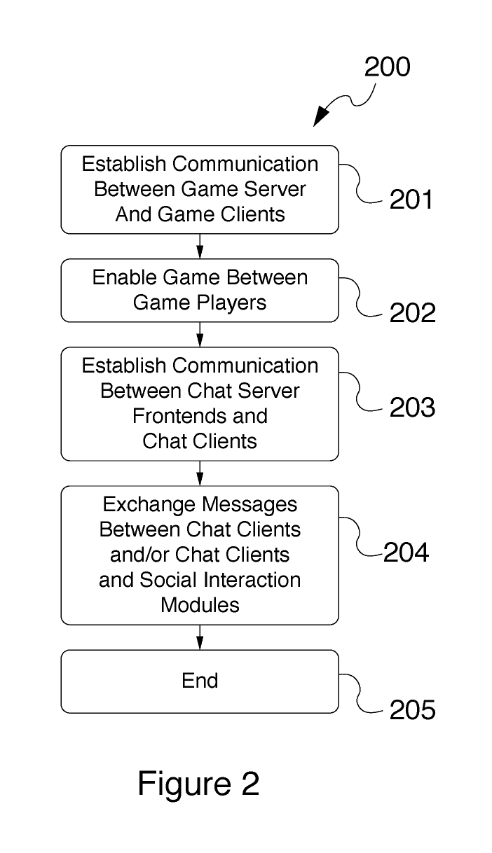

FIG. 2 illustrates an exemplary operating sequence 200 of an embodiment of the computer-implemented method for enabling extended in-game chat functionality. First, at step 201, a communication is established between the game server 102 and the game clients 107, which are directly accessed by the game players. In one or more embodiments, the aforesaid communication is established based on the login credentials assigned to each game player. The communication is conducted using the in-game communication protocol.

After the aforesaid communication is established, at step 202, the game server 102 enables the game between the players in accordance with predetermined game rules. At step 203, a communication between the frontends 103, 104, 105 and 106 of the chat server 101 and the chat clients 108, 110, 111 and 112 is established to enable the exchange of messages between the aforesaid chat clients and/or chat clients and social interaction modules 113, 114 and 115, see step 204. The messages may be exchanged between players by way of game players' participation in the in-game guilds, in-game groups and in-game chat rooms. It should be noted that all chat clients except in-game chat client 108 are not gaming chat clients. The communication between the chat server 101 and the chat clients 108, 110, 111 and 112 is established based on the same credentials as are used by the game players for accessing the functionality of the gaming server 102. The operation of the process terminates at step 205.

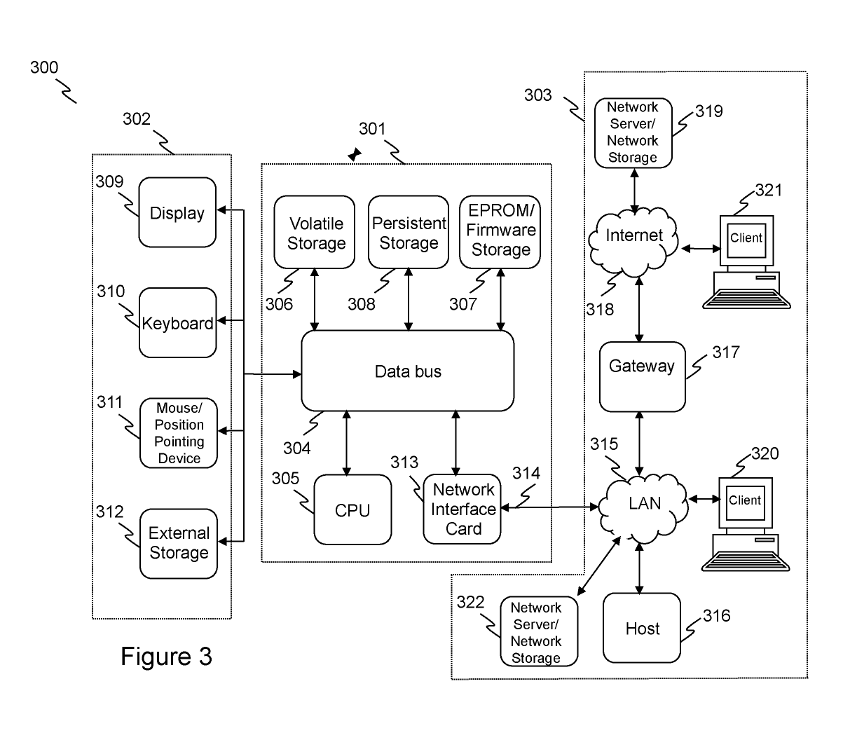

FIG. 3 is a block diagram that illustrates an embodiment of a computer system 300 upon which various embodiments of the inventive concepts described herein may be implemented. The system 300 includes a computer platform 301, peripheral devices 302 and network resources 303.

The computer platform 301 may include a data bus 304 or other communication mechanism for communicating information across and among various parts of the computer platform 301, and a processor 305 coupled with bus 304 for processing information and performing other computational and control tasks. Computer platform 301 also includes a volatile storage 306, such as a random access memory (RAM) or other dynamic storage device, coupled to bus 304 for storing various information as well as instructions to be executed by processor 305, including the software application for proxy detection described above. The volatile storage 306 also may be used for storing temporary variables or other intermediate information during execution of instructions by processor 305. Computer platform 301 may further include a read only memory (ROM or EPROM) 307 or other static storage device coupled to bus 304 for storing static information and instructions for processor 305, such as basic input-output system (BIOS), as well as various system configuration parameters. A persistent storage device 308, such as a magnetic disk, optical disk, or solid-state flash memory device is provided and coupled to bus 304 for storing information and instructions.

Computer platform 301 may be coupled via bus 304 to a touch-sensitive display 309, such as a cathode ray tube (CRT), plasma display, or a liquid crystal display (LCD), for displaying information to a system administrator or user of the computer platform 301. An input device 310, including alphanumeric and other keys, is coupled to bus 304 for communicating information and command selections to processor 305. Another type of user input device is cursor control device 311, such as a mouse, a trackball, or cursor direction keys for communicating direction information and command selections to processor 305 and for controlling cursor movement on touch-sensitive display 309. This input device typically has two degrees of freedom in two axes, a first axis (e.g., x) and a second axis (e.g., y), that allows the device to specify positions in a plane. To detect user's gestures, the display 309 may incorporate a touchscreen interface configured to detect user's tactile events and send information on the detected events to the processor 305 via the bus 304.

An external storage device 312 may be coupled to the computer platform 301 via bus 304 to provide an extra or removable storage capacity for the computer platform 301. In an embodiment of the computer system 300, the external removable storage device 312 may be used to facilitate exchange of data with other computer systems.

The invention is related to the use of computer system 300 for implementing the techniques described herein. In an embodiment, the inventive system may reside on a machine such as computer platform 301. According to one embodiment of the invention, the techniques described herein are performed by computer system 300 in response to processor 305 executing one or more sequences of one or more instructions contained in the volatile memory 306. Such instructions may be read into volatile memory 306 from another computer-readable medium, such as persistent storage device 308. Execution of the sequences of instructions contained in the volatile memory 306 causes processor 305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 305 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 308. Volatile media includes dynamic memory, such as volatile storage 306.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 305 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 304. The bus 304 carries the data to the volatile storage 306, from which processor 305 retrieves and executes the instructions. The instructions received by the volatile memory 306 may optionally be stored on persistent storage device 308 either before or after execution by processor 305. The instructions may also be downloaded into the computer platform 301 via Internet using a variety of network data communication protocols well known in the art.

The computer platform 301 also includes a communication interface, such as network interface card 313 coupled to the data bus 304. Communication interface 313 provides a two-way data communication coupling to a network link 314 that is coupled to a local network 315. For example, communication interface 313 may be an integrated services digital network (ISDN) card or a modem to provide a data communication connection to a corresponding type of telephone line. As another example, communication interface 313 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 313 sends and receives electrical, electromagnetic or optical signals that carry digital data streams representing various types of information.

Network link 314 typically provides data communication through one or more networks to other network resources. For example, network link 314 may provide a connection through local network 315 to a host computer 316, or a network storage/server 322. Additionally or alternatively, the network link 314 may connect through gateway/firewall 317 to the wide-area or global network 318, such as an Internet. Thus, the computer platform 301 can access network resources located anywhere on the Internet 318, such as a remote network storage/server 319. On the other hand, the computer platform 301 may also be accessed by clients located anywhere on the local area network 315 and/or the Internet 318. The network clients 320 and 321 may themselves be implemented based on the computer platform similar to the platform 301.

Local network 315 and the Internet 318 both use electrical, electromagnetic or optical signals that carry digital data streams. The signals through the various networks and the signals on network link 314 and through communication interface 313, which carry the digital data to and from computer platform 301, are exemplary forms of carrier waves transporting the information.

Computer platform 301 can send messages and receive data, including program code, through the variety of network(s) including Internet 318 and LAN 315, network link 315 and communication interface 313. In the Internet example, when the system 301 acts as a network server, it might transmit a requested code or data for an application program running on client(s) 320 and/or 321 through the Internet 318, gateway/firewall 317, local area network 315 and communication interface 313. Similarly, it may receive code from other network resources.

The received code may be executed by processor 305 as it is received, and/or stored in persistent or volatile storage devices 308 and 306, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the computerized systems and methods for extending in-game chat to non-gaming clients. It is intended that the specification and examples be considered as exemplary only, with a true scope and spirit of the invention being indicated by the following claims.

What is claimed is:

1. A computerized system for enabling in-game communication between a plurality of players participating in a game, the system comprising: a game server configured to communicate with a plurality of game clients, each of the plurality of game clients being directly accessed by one of the plurality of game players, the game server further configured to enable the game between the plurality of players, the game server comprising a chat server, wherein the chat server comprises a plurality of frontends, each frontend of the plurality of frontends configured to communicate with a chat client of a plurality of chat clients to enable exchange of messages between chat clients and wherein at least one chat client of the plurality of chat clients is separate and distinct from each of the plurality of game clients.

2. The computerized system of claim 1, wherein the plurality of frontends comprises a web frontend, the plurality of chat clients comprises a web chat client, and wherein the web frontend is configured to communicate with the web chat client via an HTTP protocol.

3. The computerized system of claim 2, wherein the web chat client is deployed on a web portal.

4. The computerized system of claim 1, wherein the plurality of frontends comprises an XMPP frontend, the plurality of chat clients comprises an XMPP chat client, and wherein the XMPP frontend is configured to communicate with the XMPP chat client via an XMPP protocol.

5. The computerized system of claim 1, wherein the game server comprises an in-game guild module and wherein the chat server is configured to relay messages between the in-game guild module and the plurality of chat clients.

6. The computerized system of claim 1, wherein the game server comprises an in-game group module and wherein the chat server is configured to relay messages between the in-game group module and the plurality of chat clients.

7. The computerized system of claim 1, wherein the game server comprises an in-game chat room module and wherein the chat server is configured to relay messages between the in-game chat room module and the plurality of chat clients.

8. The computerized system of claim 1, wherein the plurality of frontends comprises an in-game frontend, the plurality of chat clients comprise an in-game chat client, the in-game chat client being deployed on one of the plurality of game clients and wherein the in-game frontend is configured to communicate with the in-game chat client using a game communication protocol.

9. A computer-implemented method for enabling in-game communication between a plurality of players participating in a game, the computer-implemented method being performed in connection with a system comprising: a game server comprising a chat server, the chat server comprising a plurality of frontends, the computer-implemented method comprising:
a. establishing a communication between the game server and a plurality of game clients directly accessed by one of the plurality of game players;
b. using the game server to enable the game between the plurality of players; and
c. establishing a communication between the plurality of frontends of the chat server and the plurality of chat clients, the plurality of frontends communicate with the plurality of chat clients to enable exchange of messages between the plurality of chat clients, wherein at least one chat client of the plurality of chat clients is separate and distinct from each of the plurality of game clients.

10. The computer-implemented method of claim 9, wherein the plurality of frontends comprises a web frontend, the plurality of chat clients comprises a web chat client, and wherein the web frontend is configured to communicate with the web chat client via an HTTP protocol.

11. The computer-implemented method of claim 10, wherein the web chat client is deployed on a web portal.

12. The computer-implemented method of claim 9, wherein the plurality of frontends comprises an XMPP frontend, the plurality of chat clients comprises an XMPP chat client, and wherein the XMPP frontend is configured to communicate with the XMPP chat client via an XMPP protocol.

13. The computer-implemented method of claim 9, wherein the game server comprises an in-game guild module and wherein the chat server is configured to relay messages between the in-game guild module and the plurality of chat clients.

14. The computer-implemented method of claim 9, wherein the game server comprises an in-game group module and wherein the chat server is configured to relay messages between the in-game group module and the plurality of chat clients.

15. The computer-implemented method of claim 9, wherein the game server comprises an in-game chat room module and wherein the chat server is configured to relay messages between the in-game chat room module and the plurality of chat clients.

16. The computer-implemented method of claim 9, wherein the plurality of frontends comprises an in-game frontend, the plurality of chat clients comprise an in-game chat client, the in-game chat client being deployed on one of the plurality of game clients and wherein the in-game frontend is configured to communicate with the in-game chat client using a game communication protocol.

17. The computer-implemented method of claim 9, wherein the communication between the plurality of frontends of the chat server and the plurality of chat clients is established based on credentials assigned to each of the plurality of game players.

18. A non-transitory computer-readable medium embodying a set of computer-readable instructions, which, when executed in connection with a computerized system comprising a game server, the game server comprising a chat server, the chat server comprising a plurality of frontends, cause the computerized system to perform a computer-implemented method for enabling in-game communication between a plurality of players participating in a game, the method comprising:
a. establishing a communication between the game server and a plurality of game clients directly accessed by one of the plurality of game players;
b. using the game server to enable the game between the plurality of players; and
c. establishing a communication between the plurality of frontends of the chat server and the plurality of chat clients, the plurality of frontends communicate with the plurality of chat clients to enable exchange of messages between the plurality of chat clients, wherein at least one chat client of the plurality of chat clients is separate and distinct from each of the plurality of game clients.

19. The non-transitory computer-readable medium of claim 18, wherein the plurality of frontends comprises a web frontend, the plurality of chat clients comprises a web chat client, and wherein the web frontend is configured to communicate with the web chat client via an HTTP protocol.

20. The non-transitory computer-readable medium of claim 19, wherein the web chat client is deployed on a web portal.

21. The non-transitory computer-readable medium of claim 18, wherein the plurality of frontends comprises an XMPP frontend, the plurality of chat clients comprises an XMPP chat client, and wherein the XMPP frontend is configured to communicate with the XMPP chat client via an XMPP protocol.

22. The non-transitory computer-readable medium of claim 18, wherein the game server comprises an in-game guild module and wherein the chat server is configured to relay messages between the in-game guild module and the plurality of chat clients.

23. The non-transitory computer-readable medium of claim 18, wherein the game server comprises an in-game group module and wherein the chat server is configured to relay messages between the in-game group module and the plurality of chat clients.

24. The non-transitory computer-readable medium of claim 18, wherein the game server comprises an in-game chat room module and wherein the chat server is configured to relay messages between the in-game chat room module and the plurality of chat clients.

25. The non-transitory computer-readable medium of claim 18, wherein the communication between the plurality of frontends of the chat server and the plurality of chat clients is established based on credentials assigned to each of the plurality of game players.
